(19) United States
(12) Patent Application Publication
(10) Pub. No.: US 2007/0170106 A1
(43) Pub. Date: Jul. 26, 2007

(54) Installation and method for the treatment of sewage sludge, and membrane unit

(76) Inventors: Torsten Hackner, Ingolstadt (DE); Martin Springs, Lauterhofen (DE); Oliver Christ, Munchen (DE)

Correspondence Address: DORITY & MANNING, P.A., POST OFFICE BOX 1449, GREENVILLE, SC, 29602-1449, US

(21) Appl. No.: 10/590,597

(22) PCT Filed: Jan. 19, 2005
(86) PCT No.: PCT/EP05/50223

§ 371 Date: Aug. 24, 2006

(30) Foreign Application Priority Data
Feb. 26, 2004 (DE) 10 2004 009 886.7
Apr. 16, 2004 (DE) 20 2004 006 010.8

(51) Int. Cl. B01D 33/70

(52) U.S. Cl. 210/321.69; 210/151

(57) ABSTRACT

Equipment (6), provided for the treatment of biosludge containing a preponderant amount of fecal matter, has a fecal material receiving station (1), for the separation of sludge and filtrate. A membrane unit for the clarification of wastewater possesses a membrane module (106) and a wash chamber (105), located below said membrane module, which wash chamber has an air inlet connection, by means of which cleaning air can be injected into the membrane module (106). The membrane module (106) is also equipped with a feed inlet for wastewater and exit connections for respectively sludge and permeate. A sieve (108, 110) is located between the said wash chamber (105) and the membrane module (106) to evenly distribute cleaning air over the entire membrane module (106) and/or at the feed fitting for wastewater, the said sieve serves for the retention of larger entrained particulate. The invention concerns further an apparatus for the clarification of wastewater with a membrane unit (103) and a procedure for the operation of such equipment, whereby, in relation to the water level in the basin the operation of the permeate pump (123) is controlled and at the same time the permeate pump (123) is appropriately switched ON or OFF and is operated with different output quantities of permeate flow and/or an additional permeate pump can be activated.

The present invention concerns a membrane unit for clarification of wastewater, which encompasses a membrane module and a wash chamber located below said membrane module. The wash chamber is equipped with an air connection, whereby scavenging air can be blown into vertically aligned, filter envelopes, (hereinafter referred to as “filter plates”) of the membrane module. The membrane module, accordingly, possesses a feed line for wastewater and an exit line for sludge and permeate. In addition the invention involves wastewater clarification by having a membrane unit corresponding thereto and an overall control for the equipment so described and a method for operating of an equipment so described.

One of the pressing problems of world wide protection of environment and health is the capture and treatment of wastewater. The ability to provide the population with potable water of unquestioned purification, is extremely important. For economic reasons, however, not all households can be connected to a central treatment system, so that wastewater of such dwellings must be collected in local or combined basins designed for fecal containing material. The clarification of the wastewater is effected by sedimentation of solids in the basins. The effluent wastewater from these fecal-sludge basins can be conducted through simple, open launders to receiving tanks. In this manner, a high concentration of dangerous materials is prevented from successively accumulating in rivers, lakes and oceans. Very frequently a biological wastewater purification in accord with an activated sludge (live sludge) method also takes place. The separation of activated sludge from its water component can subsequently be carried out by settling or filtration. A wastewater permeate cleaned through an ultra-filtration system, may be employed in further uses. The therefrom collected fecal containing sludge must be removed at regular periods from the involved settling tanks and receive intensive purification. For this purification system a central treatment plant designed for fecal containing material has much to offer.

One embodiment of a membrane module for filtration of wastewater has been made known by patent application EP 1 016 449 A2. The membrane module therein described possesses filter bags, which are so placed that they stand next to one another on a carrier. A filtrate collection chamber is present, above which is to be found a top plate which is marked by slots running transversely to the said filter bags to allow permeate passage, which slots conduct permeate to collection and outlet facilities. Filters of this type can be designed for ultra-filtration for the removal of germs and solids from the flowing wastewater. The disadvantage of this equipment is that in a case of contaminated wastewater, the filters are quickly loaded and thereby diminished in carrying out of their intended function. The membrane module, on this account, calls for a relatively large amount of maintenance time.

The purpose of the present invention is to avoid the previous disadvantages and make available a membrane module for the clarification of wastewater and thereby to minimize both the service time necessary for the upkeep of the membrane module and the maintenance of equipment possessing such a module.

The elements of this purpose are achieved with the features of the independent claims.

A membrane unit in accord with the invention for the clarification of wastewater possesses a membrane module and a wash chamber with air injection located underneath the membrane module by means of which the surface of the membrane module is freed from aggregated particulate and sludge. The injected air purges, in this way, the filter plates of the membrane module with air and simultaneously bring about a turbulent flow of the wastewater which is flowing along the filter plates. The said turbulence tends to prevent the contamination and sludge particulate from adhering to the filter plates. In this manner, the filters remain in free-flow for the permeate passing therethrough. For this task, the membrane module possesses an entry fitting for the wastewater feed and a means of removing the sludge and the permeate. The wastewater is thus separated in the membrane module into a sludge portion and a permeate portion. The permeate is removed from the membrane module by an exit line, while the sludge is conducted away from the membrane module by a separate removal means. The removed sludge can subsequently be treated in equipment for fecal material containing sludge.

In accord with the invention, between the wash chamber and the membrane module is provided a sieve for the apportionment of the air. The air is distributed through the sieve of the entire membrane module in such a way, that the cleaning action of the membrane module extends itself over the entire membrane surface. The membrane module, as a result, remains fully functional for a duration wherein the filter plates do not become clogged with sludge. If, another sieve is furnished in the membrane module as an addition, or alternatively, then much entrained material is there retained, whereby a reduction of the contamination of the filter plates is achieved. By means of the arrangement of one sieve, for the apportionment of the air and again at the wastewater feed, the said wastewater will run in turbulence along the filter plates and thus preventing the retention of contaminant particulate.

As a special advantage, a perforated strip of metal has proved itself in serving as a sieve in accord with the invention. A perforated strip of metal, which especially consists of stainless steel, is simple to fabricate and enables a satisfactory turbulent flow of the air as well as of the incoming wastewater. As an alternative, it is also possible to place a mesh or a separation sieve between the wash chamber and the membrane module as well a installing the same at the inlet of the wastewater. Such sieve constructions enable an advantageous flow of air and water, which will achieve a cleaning effect on the filter plates.

The flow will be particularly favorably enhanced, if the sieve for the wastewater feed be placed above that sieve used for the inlet of air. In this way, a flow is obtained which reinforces the feed of wastewater and advantageously supports the continuous flow of wastewater across the filter plates and aids the passage of the permeate through the said filter plates.

If the sieve for the feed of wastewater is positioned essentially vertically and the sieve for the inlet of air is conversely somewhat horizontal, then, first, the apportionment action of the air and second the turbulent flow of the wastewater feed is particularly well supported.

Advantageously, the membrane unit is an aerator for oxygen treatment of bacteria in wastewater. By means of this aerator, the membrane unit can be placed in a living sludge basin and can serve as a complete unit for the treatment of the wastewater. Such a self-operating membrane unit is then conditioned to be set into a ground level clarifier in which wastewater is collected. This can be installed in an existing or a new basin or in an elevated tank. Installation thereof in a conventional multichamber basin is likewise possible, the same as in a single basin, which is equipped with the membrane unit, which latter is transferred to a activated sludge basin.

If the aerator possesses openings in an air hose, then the wastewater is charged with fine air bubbles. The aerator, in such a case, is easily fashioned, and is able, when, for instance, it is flexible in construction, to accommodate itself to the shape of the same container, namely, the wastewater tank or basin in which the membrane unit is to be installed.

If the aerator is not flexible, then it is of advantage if the position of the aerator relative to the membrane unit is directionally adjustable. Especially a swinging or a lengthening of the aerator is recommended, in order that it man align itself favorably with the membrane unit and be effective in the local situations in the wastewater basin or the wastewater tank.

Advantageously, openings in the wash chamber are provided, in order to allow the removal of sludge. The sieve, which, in accord with the invention, has been placed between the membrane module and the wash chamber, allows the passage of sludge therethrough, which would collect in the wash chamber. For this reason, the said openings are provided, through which the sludge can be recirculated back into the wastewater. The openings are advantageously located at the lower end of the wash chamber, so that the sludge, without the addition of any auxiliary equipment can be removed from the wash chamber. Generally, air injection for cleaning is found sufficient to accelerate the passage of sludge through the said openings.

If the membrane is supported on a carrying structure, then the membrane can be placed in a sunken wastewater basin, without necessitating essential reworking in the excavation nor in an elevated tank. The membrane unit can be essentially completely factory premounted on the carrying structure and subsequently installed in an existing basin. It is of particular advantage, if the carrying structure is designed to allow installation by suspension or individual insertion into a tank, especially in a ground surface wastewater basin. In this case the carrying structure positions the membrane unit optimally in relation to the wastewater basin. Special fastening to the wall of the wastewater basin or the tank is not necessary. The carrying structure with the membrane simply can be inserted into the wastewater basin or the tank.

In order to allow the membrane unit to fit in different tanks or basins, it is of advantage if the carrying structure is equipped with an apparatus to adjust the membrane unit height. With height adjustment, either in a case of erection by hanging or by inserting a carrying structure with its membrane unit, the membrane unit can be optimally positioned.

Equipment in accord with the invention for wastewater clarification possesses a membrane unit which yields a clear permeate from the wastewater feed and wherein the entrained solid material in the wastewater is removed. A permeate pump is connected into a permeate line of the membrane unit. This pump removes the permeate through the permeate line from the membrane unit and pumps this through an exit-flow line to subsequent uses, namely utility water in a household. The cleaned wastewater can obviously also be added to enhance an underground aquifer. The invented plant for wastewater clarification possesses in addition a control system, which, among other things, regulates the operation of the pump. In accord with the invention, the equipment has at least one tank for the feed of the wastewater. In this tank is placed a water level control. The equipment control is interconnected with the permeate pump and the said water level control. The permeate pump is controlled in accord with the state of the water level in the tank, whereby the permeate pump responds to control by switching ON or OFF as different quantities of wastewater are to be handled. It is also possible that the said control can activate an additional permeate pump, if such exists. By means of the control of the permeate pump in the tank, which is generally a sunken basin for wastewater, assurance is provided that the membrane unit will not run dry, whereby the filter in the membrane unit would be damaged. Beyond this, overflow of the wastewater is prevented, since differing quantities of permeate can be controlled by existing pump regulation. In addition, or alternatively, a second permeate pump may be activated if the said level meter indicates that the wastewater basin has been filled to an excess degree. Additional pump capacity prevents an overflow of the wastewater basin.

The overall equipment control is interconnected with the level control and regulates the delivery of varying quantities of the permeate from the basin. This control could also activate an additional permeate pump, and thus delivers permeate to successive components of the system. This control operates independently and requires very little maintenance attention. However, an essential advantage of the invented equipment does not rest solely in the controlled ON/OFF switching of a permeate pump for regulation of the process. An equal or greater advantage lies in the regulation of the quantity of flow through the said permeate pump, or regulation of flow branched to an auxiliary permeate pump for the purpose of maintaining a desired level in the wastewater basin. By this means, the membrane module operates under failure protection and as a result, requires less maintenance attention.

Another particular advantage of the invented equipment, is that the quantity of fluid flowing can be adjusted to that flow quantity which is at a minimum, but yet required. Once again the membrane module can be protected. The filter plates of the membrane module are not unnecessarily subjected to a high degree of differential pressure to compel eventual permeate in the wastewater to separate from sludge and pass through the substance of the filter. The capability of the equipment to operate at a satisfactory functional level is thereby extended for a very long period.

Seen as particularly advantageous and up to now not recognized, the equipment possesses only one basin, intended as a sump for large solids and wastewater. The invented equipment can also be advantageously operated in a single basin. Multichamber basins, as these are normally installed for rough sludges, would not be required prior to the purification of the wastewater in a biological stage. The invented equipment can, however, also be operated in the said multichamber basin arrangement.

A basin, where multichamber equipment is concerned and especially this being the final basin, advantageously treats activated sludge. The sludge found therein depends upon living microbial action for treatment of the wastewater, the permeate of which is separated from the sludge by the membrane module, i.e., the membrane unit.

If a flow meter is provided in the permeate line and is connected with the equipment control system, then the rate of delivery of the permeate pump comes under control. The flow meter sends a signal to the equipment control, which in turn accordingly regulates the delivery of the pump. With these data, for example, a determination can be made as to whether or not the permeate pump is operating properly. Moreover, this signal is a sign as to whether or not the membrane unit shows a satisfactory through-put of cleaned wastewater, which determines if the maintenance attention is required or a purging cycle should be initiated.

A filter measure for the supervision of the functionality of the equipment would be provided by a filter in the permeate line. Such a filter, which advantageously would be placed ahead of the permeate pump, would cause a reduction of the quantity of liquid being transported if its flow were blocked by residues escaping upstream membranes. A blocking of this added filter can give warning, that the membrane unit is no longer operating at normal efficiency, an example being, for instance, that a plate filter in the membrane unit is damaged. The clogged permeate filter reduces the through-put quantity, whereby the flow meter then issues a low-flow signal to the equipment control system.

It is particularly of advantage if the permeate pump is a self priming pump. Self priming pump ability will allow dispensing with special operational measures for the permeate pump if the basin is empty or if the permeate pump is placed in a start-up mode. Obviously, the equipment can also be run with a non-self priming pump, even if this is not most advantageous method.

If a blower communicates with an air inlet connection of the wash chamber of the membrane module and/or the aerator, then the activation of the basin by an appropriate oxygen supply to the microorganisms is carried out. Beyond this, by means of the aeration of the wash chamber and the aerator the membrane module is cleaned, whereby the maintenance thereof is considerably reduced.

Advantageously, the level measurement device is constructed on the float principle. The float is on the surface of the wastewater in the basin thus signaling that level to the control system.

It is of particular advantage, if an additional exit line is provided for the increase of the pump capacity. This auxiliary outlet line can be opened or closed on a need-basis, thus throttling the requirement of the permeate pump as to a delivery of more or less permeate. The permeate pump in such an arrangement can then be driven at a constant speed of rotation, whereby, principally through a variation of the allowed exit flow, the delivered volume of the permeate pump can be regulated.

If the additional exit flow line possesses a controllable shutoff valve, then this valve can be controllingly opened or closed, that is to say, regulated by its flow related cross-section.

By means of a throttling valve, which can be provided in the exit flow lines, the delivery of the permeate pump can again be controlled.

If a determination has been made, that the necessary delivery rate of the pump has not been reached, or that the cleaning of the wastewater is not satisfactory, then the control system will release a warning signal. This warning signal, issuing from the equipment can be communicated either by an optical or an acoustical method. However, it is also possible that a transmission of the signal, for example, can be sent by a mobile telephone network. In such a case, appropriate corrective measures can be exercised. These measures, for example, can include removing a blockage of feed or issuing an alarm directly to maintenance personnel.

In a procedure in accord with the invention for the operation of a clarifier of wastewater, which clarifier has, namely, a membrane unit, a permeate pump and an equipment control system, it is possible that one tank or a basin can serve as an activated basin. In the case of a multichamber installation, advantageously the final basin can be so converted. It is, however, also possible to operate the invented procedure with a single basin, or one tank. In this tank, or basin, a membrane module can be inserted for the separation of permeate and activated sludge. By means of introduction of oxygen and microorganisms, the wastewater is biologically cleaned. If an ultrafiltration membrane is selected for the membrane module, then the mix of clear permeate and sludge can be physically separated and the clear effluent taken up by the permeate pump.

In accord with the invention, the operation of the permeate pump is controlled by the liquid level in the basin and in this relationship, the permeate pump is switched ON or OFF to achieve different pump-deliveries and/or an auxiliary permeate pump may be activated in order to pump a larger quantity of liquid out of the said basin. The different flow quantities bring about a more or less rapid emptying of the basin (or tank) in which the membrane unit has been placed. This reduction in the basin content is carried out in a particularly protective manner for the membrane module. If the feed input into the basin is too small, then the liquid removal is carried out at a small transport rate. In this case, the filter in the membrane unit is only lightly loaded and the life expectancy is clearly increased, since the through-put of permeate proceeds with reduced force. If it is determined, that the basin has filled to the maximum, then it is necessary to remove a greater quantity of the clean wastewater from the said basin. In these cases, the delivered flow of the permeate pump is increased and/or an auxiliary permeate pump is brought into action. The height of liquid in the basin, in such a situation is quickly brought back to that level which is desired.

Advantageously, with the invented procedure, several levels in the basin are of key interest. If the permeate pump is stopped at a first depth of water level, then assurance is given, that the membrane unit is not empty and the activated sludge basin is continually supplied with adequate water. Only if this first depth water level is overstepped, would the permeate pump be operated at a normal delivery of liquid flow. This condition of operation is maintained, until a second and higher water level is reached in the basin. Above this second higher water level the permeate pump is operated at yet higher delivery rate, whereby the permeate is more quickly pumped out of the basin. The operational effort would then be to achieve a normal condition between first depth level and the second and higher water level, since this is most favorable for the activation (live sludge) basin and for the membrane unit. It is also possible that even a third water level can be established, which would lie above that of the described second level. This third water level would signal that the infeed is to be stopped in order to prevent overflow from the basin.

The delivery flow of cleaned wastewater can also be increased, in that upon an overstepping of the mentioned second higher water level, an additional exit line from the permeate pump is opened. In this way, it is possible that the permeate pump can always be driven at the same motor speed of rotation, although, by a variation of the exit flow line out of the permeate pump the delivered flow is however, changed. This can be achieved by throttling the said additional exit line from of the permeate pump.

Obviously, the control of the delivered permeate flow is not necessarily limited to a definitely adjusted water level. It is also possible that a change of pump delivery can be stepless or fitted to the water level in a multitude of fine increments.

It is of particular advantage if an aerator for the basin is operated in conjunction with the water level. The activated sludge basin is purposely supplied with oxygen and has the special action of guiding the wastewater to be purified to the membrane module. By means of the aerator, a further action takes place, in the case of a membrane unit with a sieve, in that the sieve is not clogged with entrained solids and is kept clear by turbulent flow of the to be treated wastewater. The aerator can thus serve along with the oxygen supply to the bacteria for the cleaning of the membrane unit, which, by this action, needs maintenance attention much less frequently.

If a cleaning infusion of air be operated for the membrane unit by signals from the water level, then, especially, in a case of a low level of the basin content, wherein the permeate pump would be stopped, this air can continue to clean the membrane unit, so that the filter plates remain ready for operation.

If the aerator is operated intermittently with pauses, once again continuous cleaning of the membrane unit and continuity of the oxygen feed can be maintained.

If the functionality of the equipment is supervised by the flow meter, then it is very easy to determine whether or not the membrane unit or, for example, a control filter in the permeate line, is blocked or damaged. Especially in a case where the membrane unit possesses a defective filter plate, more contamination in the permeate line accrues and/or contamination in the cleaned wastewater appears. If a safety filter is installed in the in the permeate line, then this will be very quickly clogged and the flow through the permeate line will be reduced. The flow meter can register this and send a corresponding signal to the equipment control, i.e., can make the deficiency known.

It is particularly of advantage, if, upon a disturbance of the equipment a warning signal be activated. The warning signal, for example, can be sent by mobile telephone requesting a maintenance service to remove the difficulty. Further, in such a case, a shutdown of lines can be effected or the equipment brought into a failure mode, in which the equipment itself can attempt to correct the deficiency.

For such a self-correction of a difficulty, it is of advantage, if a cleaning program is started. The cleaning program acts, in this operation in an advantageous manner, so that the permeate pump and/or the aerator and/or the air be operated intermittently. In this way a blocked sieve or a clogged filter plate can be made operational once again.

In particular, if the said cleaning program does not lead to success, it is of particular advantage of the permeate pump and/or the aerator and/or the air are at least temporarily shut down. In this way a damage-situation can be prevented from becoming even greater. Especially the aeration would at least be made better use of, if the activated sludge basin were provided with oxygen.

It is of particular advantage if: with a pressure measurement, an oxygen measurement, a measurement of the degree of clarification, or a turbidity measurement of the permeate, the functionality of the equipment is considered to be supervised. These measurements characterized themselves as particularly effective in regard to controlling the correct operating condition of the clarifier, since an alteration of any of these parameters points directly or indirectly to a fault in the function of the equipment.

It is of particular value if the turbidity measurement is carried out with a sight-glass, which would be installed in the permeate line. The view glass can, for example, be monitored by a service person. As an alternative, the turbidity measurement can also be executed by an optical photometric system, whereby, once again, the conclusion could discover a defined fault.

It is of particular importance if the measurement of the degree of clarification be carried out with precision by means of CSB-measurement (oxygen requirement). The contamination in the permeate can be especially accurately determined by this method.

Additional advantages of the invention are to be found in the following embodiments. There is shown in:

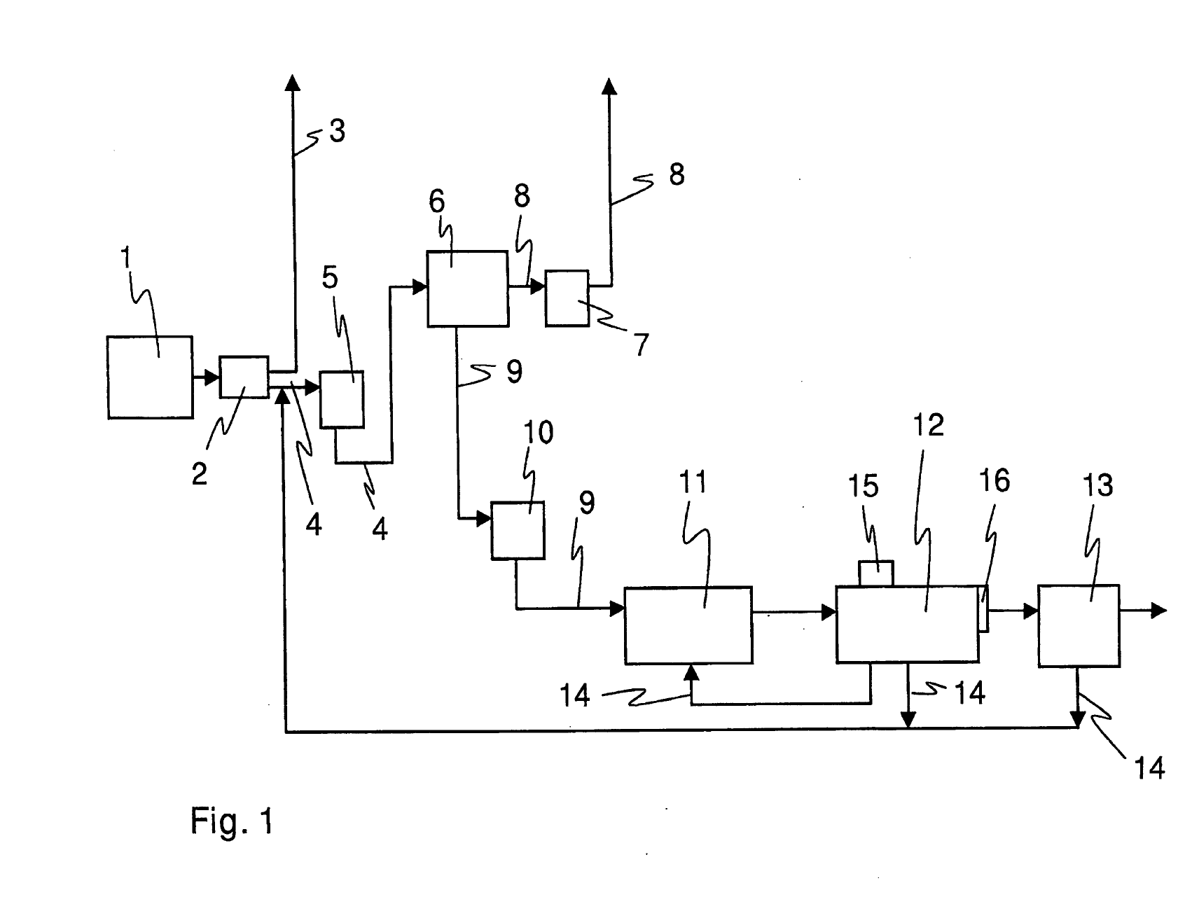

FIG. 1 a schematic presentation of an equipment for sludge which incorporates fecal material inclusions,

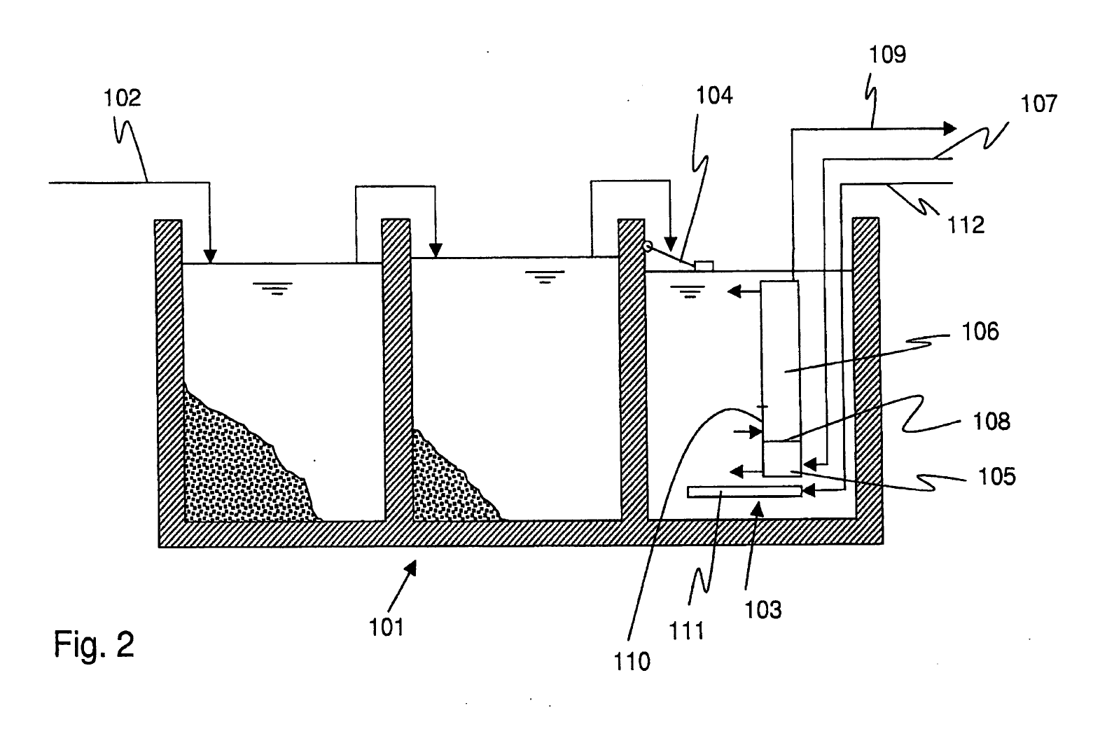

FIG. 2 a schematic illustration of invented equipment for wastewater clarification,

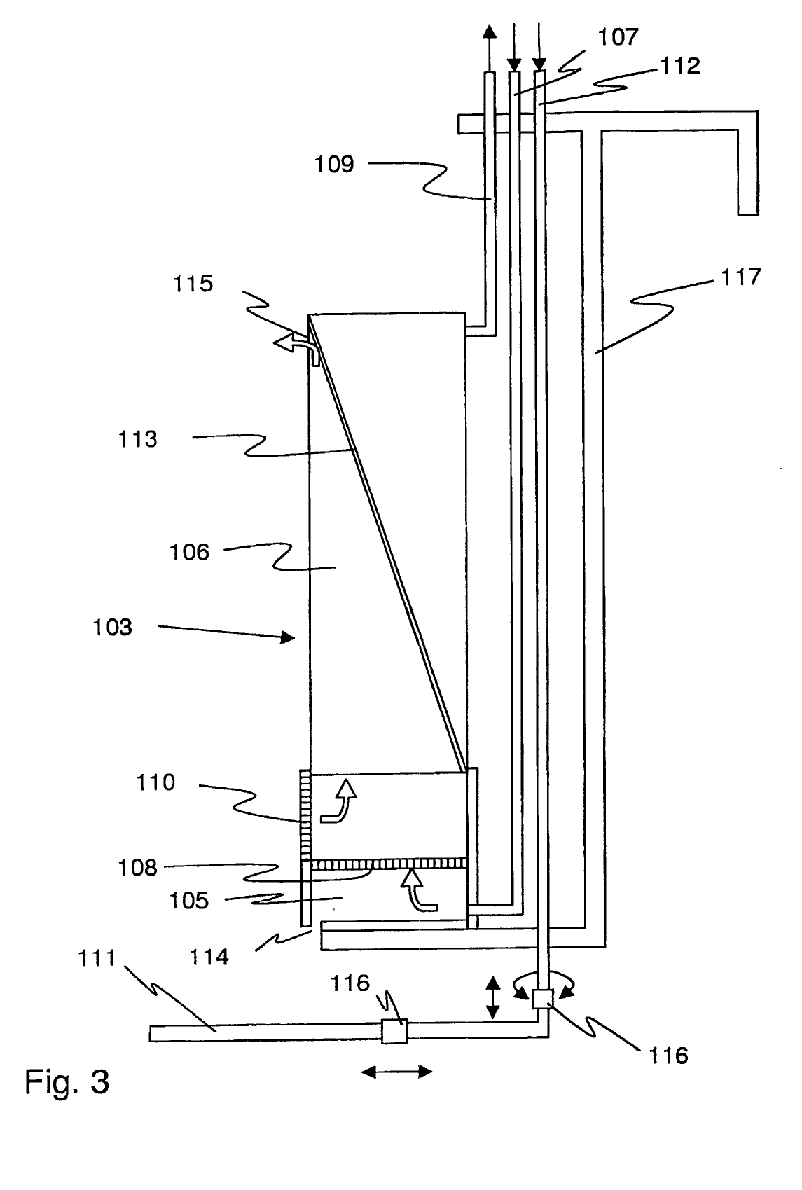

FIG. 3 an invented membrane unit and

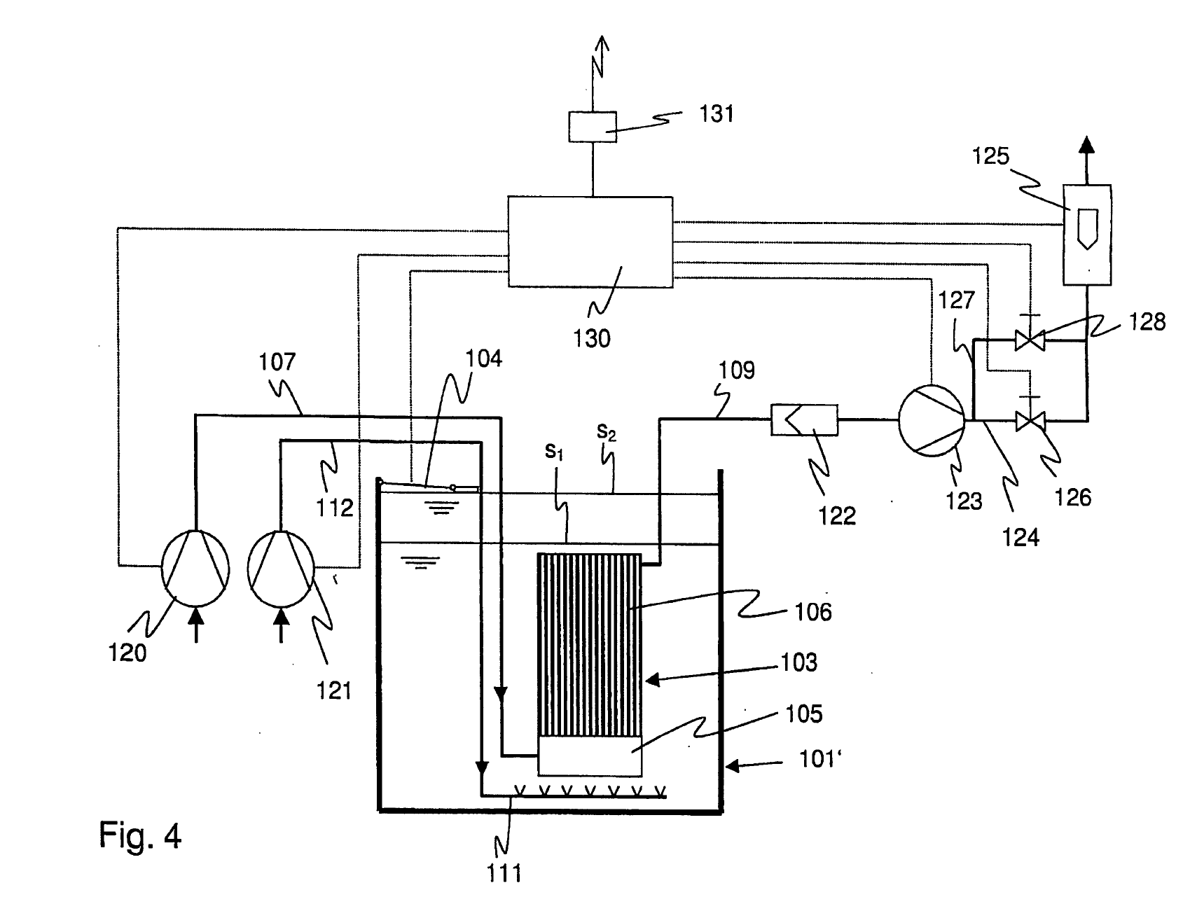

FIG. 4 a schematic presentation of the control of the invented equipment for wastewater clarification

In FIG. 1, equipment for fecal containing sludge treatment is sketched and includes the various connections and process units. In the fecal sludge receiving station 1 household and industrial off-waters, as well as run-off water and sludges are collected. These materials are delivered as wastewater to ground level fecal material basins. In these fecal containing sludges other impurities are contained, including, for example, rags, hygiene articles, wood detritus, stones and the like. So that the functions of the subsequent equipment, such as pumps and dewatering units in the successive process are not damaged, these solid materials are removed from the fecal centered sludge in a rough material cleaning section 2. The rough material 3 is subsequently, for example, disposed of in an environmentally friendly landfill or incinerator plant.

Further, separated fecal materials 4 are separated in the heavy solids materials removal section 2 and forwarded to the special fecal material collector 5. This now mechanically cleaned fecal sludge, however, still possesses a substantial quantity of wastewater. On this account, this fecal mixture is now conducted to a sludge dewatering process 6. By means of this dewatering 6, a separation is achieved between the solids 8 still retained in the fecal transport lines 4 and the liquid elements 9, which appear as filtrate. The sludge dewatering is carried out, for example, with a worm press. In this worm press, the sludge is continually dewatered by the pressure increase characteristic of a worm conveyor. The solids 9 of the dewatered sludge, at the conclusion of the dewatering, normally have a crumb-like consistency and, similar to the heavy materials 3, are transported to a landfill or an incinerator. The possibility also exists that the residues can be composted and so realize an additional economic advantage.

From the sludge dewatering unit 6 besides the removal of sludge through line 8, a second line carries away a liquid filtrate 9. The filtrate in 9 is once again collected in a tank 10. Upon need, filtrate 9 is taken out of the said filtrate collection tank 10 and conducted to am aeration basin 11. In the said aeration basin 11 the solid residues of the filtrate 9 are sanitized, i.e., conditioned and the preliminarily cleaned water is treated biologically.

The activated sludge mixture of the aeration basin 11 flows into a secondary clarifier 12, where the sedimentation procedure separates the heavy sludge from the clear water. On the surface of this secondary clarifier 12, highly cleaned wastewater is diverted by reflux into a main channel line. From the bottom part, the settled, thick sludge 14 is returned to the aerator 11 or, in a renewed effort, is brought back to the fecal collection tank 5.

Before the wastewater removed from the secondary clarifier 12 is conducted to the general main, it is again run through a filter 13. The filter 13 is normally a cloth filter, wherein a felt fabric is stretched over a drum and the residual solid particulate is largely removed from the cleaned wastewater. This filtration sludge 14 is advantageously returned to the fecal collector 5 and in the sludge dewatering unit 6 be returned to the basin 7. Another possibility is to conduct the said filtration sludge to the activated sludge basin 11.

Besides the treatment described here, it is possible to carry out a clarification of the filtrate by means of membrane equipment. The membrane unit in this case, as illustrated in FIG. 2, can be installed in a multichamber basin, likewise the clarification of the filtrate can be effected in a single basin with a membrane unit.

In the secondary clarifier 12 is also installed a removal unit 15 for entrained sludge and a retention apparatus 16 for suspended material. These devices assure prevention, that in the case of an increasing sludge level and an increased hydraulic capacity, sludge could migrate into a removal main. Otherwise, in the secondary clarifier 12, all sludge and heavy materials are removed from the activated sludge and water mixture. This will guarantee the yielding of a wastewater product which is as far as possible, free of harmful material.

In FIG. 2 is shown schematically a multichamber basin 101 of a decentralized clarification system. What is exhibited here, for example, is the said multichamber basin 101, which has been formerly been used for the collection of wastewater. By means of an entry line 102 the wastewater enters the first chamber of the multichamber basin which then serves as a settling tank for rough sludge components. For example, by means of an inlet pipe, the wastewater, which is burdened with rough sludge, runs into a second, middle basin which further acts as a settling and buffering means. In this basin additional heavy sludge is allowed to settle. The settled sludge must be removed from the basin(s) at regular periods and can be additionally treated in equipment for fecal sludge handling. Once again, for example, with an under-surface inlet pipe, the largely cleaned wastewater enters the final chamber, which can serve as a biological stage with ultra filtration, this being made contrary to the previous usage of the final basin. For this purpose, in this final basin, there is found an invented membrane unit 103 and a float 104. The membrane unit 103 and the float 104 are placed in the final basin, whereby the available multichamber basin 101 can be further put to use, and wherein the wastewater containing contamination particulate and nutrient material under air feed can be deactivated and converted to a biomass. The membrane unit can carry out the separation of clear wastewater from the activated sludge. The float 104 serves for the determination of the height of the fluid in the final chamber, which is a requirement for the operation of the membrane unit 103.

The membrane unit 103 consists essentially of a wash chamber 105 and a membrane module 106. In the wash chamber 105, upon requirement, air can be blown by means of an air line 107. This air passes through the wash chamber 105 into the membrane module 106. The wash chamber 105 and the membrane module 106 are separated from one another by a sieve 108. The untreated wastewater enters the membrane module 106 at the lower end thereof and, by means of the air, is forced from below upward through the membrane module 106 and is subjected to a cleaning action with the aid of the filter which is located therein. At the upper end of the membrane module 106 the sludge is expelled from the membrane module 106 and is to be found once again in the basin, while, at the same time, the cleaned wastewater which has passed through the filter exits the basin through a permeate line 109. For the suction collection of the still uncleaned wastewater at the lower end of the membrane module 106, an additional sieve 110 is provided which clears the dirty wastewater from rough entrained particles, so that the filter in the membrane module will not be unduly overloaded with contamination. By means of the air, which flows by means of the cleaning enclosure 105 through the membrane module 106 with individual filtering is cleaned, since a particularly turbulent flow is caused to move along the filter surface and thus the adherence of dirt particles on the filtering surfaces is prevented.

Contamination, which may pass through the sieve 108 into the wash chamber 105 can be removed through the lower openings of the wash chamber 105, which action prevents a clogging of the said wash chamber 105.

The last basin of the multichamber basin 101 is designed to serve as an activated sludge basin. For the supplying added microorganisms with oxygen, an aerator 111 is made an adjunct to the membrane unit 103. The aerator 111 is delivered oxygen through the aeration line 112 which it feeds into the said activated basin and by means of an appropriate arrangement relative to the membrane unit 103, a turbulence is created in front of the sieve 110. This turbulence of the wastewater forward of the sieve 110 brings about such action that the said sieve 110 likewise remains free of adhering contamination particulte and consequently does not become clogged. The maintenance of the membrane unit 103 is thus very much reduced, since it is designed to be essentially self-cleaning.

FIG. 3 shows schematically a membrane unit 103. The wash chamber 105 is indicated as being bound to the membrane module 106. Between the wash chamber 105 and the membrane module 106 is placed a sieve 108, through which air, continually introduced through the line 107 into the wash chamber 105, can flow into the membrane module 106. Because the entry of air into the membrane module 106, wastewater also flows into the membrane module 106 through the sieve 110. The sieve 108 acts to allow an apportionment of the air flow across the entire membrane module 106 as well as forming a turbulence in the wastewater entering the membrane module 106. The turbulence has such an action, that a present, very schematically presented filter plate 113 is continually cleaned of adhering contamination and therefore remains permeable for the cleaned wastewater. The action of the sieve 110 has the result, that large particles of contamination, which may be found in the wastewater from the membrane module 106 can be held back. Principally, a contamination of fines is prevented from adhering onto the filter plate 113. The filter plate 113 is generally not designed as it is here illustrated. More exact layouts of the membrane module 106 with the therein placed filter plates 113 can be found in EP 1 016 449 A2. Obviously, however, other designs of the membrane module 106 can be employed with the present invention.

In order to be able to remove contamination which has again migrated through the sieve 108 into the wash chamber 105, this wash chamber has openings 114 on its lower end. The contamination can be rinsed out of the wash chamber 105 through these openings 114 and thus cannot block up the wash chamber 105 as well as the sieve 108.

While the sludge remains on the wastewater side of the membrane module 106, the clear wastewater can percolate as permeate therethrough. The retained sludge can be extracted from the membrane module 106 through a upper opening 115 of the membrane module 106. The cleaned wastewater finds an outlet through the permeate line 109 from the membrane module 106 and hence exits the basin.

In the case of the present design of the invention, an aerator 111 is made a part of the membrane unit 103. The aerator 111 is connected to the air line 112. The connections 116 allow the aerator 111 in its position relative to the wash chamber 105 and the membrane module 106 in its position to be changed. In this matter, the aerator 111 can as well be turned in regard to its length, whereby the sieve 110 is subjected to air bubbles by a corresponding positioning of the aerator and in this way adhering entrained materials are removed from the sieve 110. The aerator 111, which first, serves for the delivery of oxygen to the sludge activation basin, serves in a second function for self cleaning of the membrane unit 103. It is possible that additional aerators can be installed in the basin.

The membrane unit 103 is placed on a carrier framing 117. This can be supported by suspension in an existing basin or tank and if required, adjusted as to its height by a positioning device. The membrane unit 103, for maintenance purposes, can be completely lifted out of a basin. A reequipping of existing basins with this method of construction is entirely possible. Instead of a carrying framing, 117, which, in the case of the embodiment illustrated here is furnished for the suspension of the membrane unit in the basin, obviously also a carrying support can be furnished which is provided with feet and can be set into the basin.

FIG. 4 shows again schematically, how an invented apparatus can be operated. In one tank or one basin 101′ is presented a membrane unit 103 with the wash chamber 105 and the membrane module 106. In the basin 101′ is to be further found a float 104, which states the level of the wastewater in the said basin 101′. By means of a blower 120 and the cleaning air 107, air is blown into the cleaning enclosure. The aerator 111 receives the aeration air by means of the air line 112 and a blower 121. The cleaned wastewater is removed by suction through the permeate line 109 and a filter 122 by means of a permeate pump 123. The permeate in the line of the permeate pump 123 is pumped out through the exit line 124 and a flow meter 125. At the outflow-line 124 is placed a valve 126, which can change the through-flow of the output line 124. Parallel to the outlet line 124 is provided another outlet line 127, which, in typical by-pass piping possesses another valve 128. The outlet line 127 and/or the valves 126, 128 are, in accord with need, more or less opened, in order to enable a certain amount of through-flow. By means of this change of the through-flow and therewith also the delivery volume of the pump 123, the water level in the basin 101′ is regulated. If the water level is too high, then the output delivery of the pump 123 is increased, since, for example, the outlet line 127, in addition to the outlet line 124 is opened. If the water level in the basin 101′ be too low, then, for example, the outlet line 127 is blocked or one or both of the valves 126, 128 is throttled down, in order to reduce the delivery volume of the pump 123. The pump 123, generally, can run at a constant speed of rotation. The quantity of the flow determines itself, so to speak, in accord with the total cross-sectional opening of the outlet lines 124, 127.

A control 130 supervises and controls the invented equipment. Relative to the liquid levels, which is reported by the float 104 to the control 130, the pump 123 varies between its ON/OFF positions. If the float 104 determines that water level S₁ has been attained, then the pump operation is stopped. At a water level S₂, the signal is given, that more permeate is to be pumped out of the basin and the outlet piping 124, 127 is increased in cross-section or opened. Through the open valves 126, 128 the delivery flow of the pump 123 is increased and more permeate is pumped out of the basin 101′. For an increase of the transported permeate, provision can be made that additional permeate pumps can be supplied.

The water level also contributes to the control of the feed of cleaning air and aerator air. The blowers 120 and 121 are accordingly switched ON/OFF. In a cleaning operation these blowers can be run independently of the pump 123. The blower 121 serves for the supply of oxygen for the activated basin 101′, while the blower 120 advances cleaning air into the wash chamber 105 and the membrane module 106. In this way, the transport of the wastewater through the membrane module 106 is activated. Particularly, in a case of a low water level, whereby permeate is not pumped out, the operation of the blowers 120, 121 is possible on an intermitted basis, in order to supply the activation basin continually with oxygen and to avoid or loosen any contaminate deposition on the membrane module 106 or its filter.

For the determination of a disturbance, the flow meter 125 and the filter 122 are provided. If, for instance, the membrane module 106 is damaged, with the result that contaminated wastewater infiltrates into the permeate line 109, then the filter is very quickly clogged or at least the through-flow is clearly reduced. By means of the flow meter 125, this is signaled to the control 130, whereupon, by means of the control 130 a disturbance signal is emitted by a sender 131, which, for example would inform the maintenance personnel. Moreover, the control 130 can release a disturbance program, wherein, an interval washing first attempts to clean the filter in the membrane module 106. If this does not lead to success, then the next step is that actually a maintenance action must be undertaken. The signal sender 131 can broadcast an appropriate signal by radio, or by a mobile telephone network, or a fixed telephone network to an appropriate central maintenance station. Moreover, obviously also other measures are possible. For instance, the feed to the basin 101′ can be blocked or acoustic or optical signals generated and sent.

The present invention is not limited to the here presented embodiment examples. Likewise combinations of the individual embodiment examples are entirely possible. Especially in the membrane equipment, the combination of the various lines such as the cleaning air line 107 and the aeration line 112 can be joined to a common blower. A control of the two lines 107 and 112 can be worked out with additional valves, which can be placed under the regulation of the control 130. Instead of the flow meters 125, it is also possible to bring in another measuring system for the determination of a disturbance. It is possible that the filter 122 can be substituted for. Instead of the float, obviously, also another measurement system for the determination of the water level can be employed. Further deviations within the framework of the patent claims are possible at any time.

1. Equipment for the treatment of fecal containing sludge with a fecal material receiving station (1), therein characterized, in that an apparatus is in the subject equipment (6) for the separation of sludge and filtrate.

2-56. (canceled)
